(19) United States
(12) Patent Application Publication
(10) Pub. No.: US 2002/0054630 A1
(43) Pub. Date: May 9, 2002

(54) Method and apparatus for transformation of a signal

(76) Inventor: Gerald Hoefer, Schwabmuehlhausen (DE)

Correspondence Address: Jordan and Hamburg LLP, 122 East 42nd Street, New York, NY, 10168, US

(21) Appl. No.: 09/837,985

(22) Filed: Apr. 19, 2001

(30) Foreign Application Priority Data
Apr. 20, 2000 (DE) 100 19 602.0

(51) Int. Cl. H04B 1/38; H04L 5/16; H04B 3/00

(52) U.S. Cl. 375/222; 375/257; 375/377

(57) ABSTRACT

A method and an apparatus for the transformation of a signal on a four-wire line are proposed where the signal comprises of discrete amplitude height levels that are intended for a conversion into a corresponding analog signal with amplitude height levels suitable for a two-wire line and the analog signal is intended for a data communication unit that connects to the two-wire line and which has a predefined amplitude resolution for the analog signal. The amplitude height levels of the signal on the four-wire line are transformed in such a way in the domain of the four-wire line that the number of amplitude height levels which the communication unit can discern in the analog signal match a presetable criterion.

The presented invention relates to a method and an apparatus for signal transformation as well as a method and apparatus for detection of a modem connection. The methods and apparatus apply at data communication, in particular at data communication between modems over a telecommunication network.

Although modern public switched networks (PSTN) are already mostly digitized the majority of subscribers are connected by analog links. These links are primarily designed for transmission of voice by phones (acoustic coupling). Therefore the digital pulse code modulated (PCM) signal used for transmission over a four wire line within the digital part of the telecommunication network must be transformed into a corresponding analog signal (information carried in the amplitude) for transmission over a two wire line to the subscribers equipment. This transformation is commonly done at a piece of equipment called subscriber line interface card.

According to ITU recommendation G.711 the PCM signal transmitted over the digital part of the PSTN uses a logarithmic characteristic for the conversion of analog amplitudes into discrete levels. These discrete levels shall be called PCM values or amplitude height values in the following. PCM values can be positive or negative.

The transformation of the digital PCM signal into the corresponding analog signal for the subscriber is done as follows on the subscriber line interface card: First the amplitude height values with logarithmic characteristic are converted into digital values with linear characteristic (G.711/linear conversion). Then the digital values are converted into analog amplitudes by a DAC. Then the analog signal is converted for the 2-wire line.

ITU recommendation V.90 is well known and common practice for communication between a digital PCM modem on one side (provider) and an analog PCM modem on the other side (client) over a PSTN as described above. ITU recommendation V.90 specifies the PCM based signal transmission from the provider to the client side. The digital modem sends a signal comprising PCM values, which represent analog amplitudes according to G.711 (e.g. by ISDN). The analog PCM modem on the client side receives the corresponding analog signal over the 2-wire line. The subscriber line interface card has generated the analog signal. Therefore the analog PCM modem must recreate the originally sent amplitude height values from the analog signal according to G.711.

In the best case a data rate of 56000 bit/s can be achieved on the direction from the digital modem to the analog modem when using V.90. In reality the data rate achieved is mostly lower. One reason for that degradation is the already mentioned optimization of the PSTN for voice telephony. In order to avoid echoes during a voice conversation the PSTN inserts a well-defined attenuation. For this purpose the signal received by the subscriber line interface card from the digital network is attenuated by a gain stage with a sufficiently small gain factor. The attenuation can be done by a multiplication in the digital domain by multiplying each digital value after the G.711/linear conversion with a value smaller than 1. The gain stage can also be an analog amplifier in the analog domain after the DAC. The predefined attenuation of the received signal results in an attenuated signal (e.g. −7 dB) at the output of the subscriber line interface card. The amplitude height values of the digital signal are therefore converted into an analog signal with somewhat smaller amplitude. As a consequence the analog signal on the analog line to the PCM modem of the subscriber does not use the full scale. Therefore interferences caused by the D/A conversion (resolution errors, non-linearity, idle channel noise) or interferences by noise induction on the analog line have a stronger impact.

As every modem has a limit below which two analog amplitudes cannot be discerned it is not possible to refine resolution at will. Therefore the attenuated signal received by the PCM modem on the client side cannot be resolved with the same number of amplitude levels as the not attenuated signal. As a remedy the digital modem would have to send a digital signal comprising amplitude height values representing a wider range of amplitudes to achieve full scale analog signal range after attenuation has taken place. However, this is a limited option in reality because the DAC on the subscriber line interface card has a limited range and would introduce non-linearity errors for amplitude height values with too high corresponding analog amplitude. Therefore the data rate that can be achieved in reality results from the minimal distance between two discernable analog amplitudes at the client PCM modem, the available amplitude levels as defined by G.711 and the maximum transmit power level.

According to V.90 the client side PCM modem tells the digital modem which amplitude height values shall be used for a particular communication. This set of values is referred to as constellation. The constellation is determined as follows: The client side PCM modem first evaluates probing signals sent by the digital modem. During evaluation it determines the PCM value that corresponds to the smallest amplitude difference it can discern. The remaining amplitude height values are then calculated by taking into account the logarithmic characteristic according to G.711, the signal range of the analog modem and the power limit for the digital signal as imposed by V.90. According to the state-of-the-art the constellation is therefore adjusted to the characteristics of the analog line. The resulting data rate cannot be set individually by external control of the modem.

Already known are subscriber line interface cards that can discern modem connections from voice connections and which, as soon as a modem connection is detected, use a broader band-filter than with voice connections. This method applies to the settling time of the filter, however. The achieved data rate is affected marginally only. Furthermore there are two fixed settings for the filter only, one for voice connections and one for modem connections. Both settings do not depend on the actual characteristic of the current connection within the PSTN and they are chosen at the beginning of the connection.

Problems of the same tenor occur for communication between other devices over the PSTN, e.g. fax machines,

The object of the invention is therefore to provide methods and systems which allow for a maximum, respectively predefined, data rate for communication connections over the PSTN.

This object is achieved according to the invention by the methods and systems according to the independent claims. Preferred embodiments are described in the dependent claims.

The invention proposes a method to transform a signal carried on a four-wire line which comprises discrete amplitude height values intended for a conversion into a corresponding analog signal with analog amplitudes carried on a two-wire line. The analog signal is intended for a data communication unit that is connected to the two-wire line and which has a predefined resolution capability for the analog signal. The amplitude height values on the four-wire line are transformed in such a way that the number of amplitude levels of the resulting analog signal which the communication unit can discern matches a criterion that can be predefined.

The invention uses the insight that the number of discernable and therefore usable amplitude levels can be affected by a transformation of the amplitude height values carried on the four-wire line in such a way that a maximum respectively predefined data rate for communication can be achieved.

This leads to a variable transformation of amplitude height values as opposed to the commonly used gain (attenuation) of the signal that is fixed for the complete duration of the connection and which is also independent of the individual characteristics of the (analog) two-wire line.

The aforementioned criterion can be the maximum number of discernable amplitude levels. This is equivalent to maximizing the data rate.

If the criterion is a predefined range of the number of discernable amplitude levels then data rates of a predefined range can be achieved. Therefore the range can also be a predefined to a small number of discernable amplitude levels if only a predefined low data rate shall be permitted (e.g. by a Telco).

The transformation may be realized by a multiplication of the amplitude height values with a factor. A multiplication unit can implement this.

Advantageously, the factor is calculated by the evaluation of the constellation used, for example by determination of the smallest analog amplitude difference the communication unit can discern.

The signal can comprise amplitude height values of a predefined characteristic, especially according to ITU recommendation G.711 that is used in many PSTN.

The factor used for the transformation can be calculated from a constellation whose PCM values have been multiplied by a predefined small factor, especially a small factor for which the resulting constellation contains at least three amplitude height values with the following property: the discernable amplitude difference deviates less than 25% from the respectively previous amplitude height value.

The factor can be calculated by applying the following steps:

a) Determination of the smallest amplitude height value that is greater or equal to the smallest amplitude difference the communication unit can discern

b) Determination of the largest amplitude height value whose UCODE-difference to the next higher PCM value meets a predefined criterion

c) Calculation of the difference between the amplitude height value according to (b) and the amplitude height value according to (a)

d) Counting the number of amplitude height values in between the largest and the smallest amplitude height value used in the constellation and reducing this number by one

e) Dividing the difference according to (c) by the reduced number according to (d)

f) Multiplication of the predefined small factor with the result of (e).

The predefined criterion may be “at least 4”.

Furthermore it is advantageous if the transformation is done by a table look-up where every encountered amplitude height value is used as an index to the table and the table contains amplitude values that have been calculated beforehand. The table can be calculated by multiplication of the amplitude height values with a factor.

The transformed amplitude values may have a reduced accuracy as opposed to an exact value, especially they may be represented by at least 12 bits.

The method may be applied in either the digital or analog domain (i.e. after the DAC), however still in the realm of the four-wire line.

The communication unit may be a PCM modem and the signal may originate from a digital modem. The method is suitable for V.90.

The method is compatible with voice telephone if at the start of a communication modem detection is performed and the inventive transformation is applied only when a modem connection is detected. A preferable modem detection method is also described in the invention. In this case the optimized amplification is only applied when there is a modem connection. Otherwise the attenuation for voice telephone remains selected.

For this purpose the invention also contains a method for detection of a modem connection that comprise the following steps:

a) Checking whether the signal represents a silence period in between 70 ms and 80 ms and, if the signal amplitude during the silence period meets a predefined low amplitude height value, output of a modem detect signal

b) otherwise, if the silence period exceeds 80 ms, checking whether the signal following the silence period represents a predefined characteristic signal of a PCM modem; if true output of a modem detect signal.

The occurrence of periodic signals is characteristic for the start of a modem connection.

A sequence of ten amplitude height values, followed by the same sequence with reversed sign can be identified as a periodic signal.

Furthermore a periodic sequence of six amplitude height values with three constant positive values and three constant negative values can be identified as a characteristic signal.

Furthermore a periodic sequence of amplitude height values {P, 0, P, −P, 0, −P} with 0 being the smallest valid amplitude height value and P any other valid amplitude height value can be detected as a characteristic signal. P may be either a positive or a negative value.

During modem detection favorably amplitude height values with a distance of up to two values from the amplitude height value that shall be detected can be regarded as the amplitude height value to be detected.

The inventive method for detection of a modem connection allows a reliable distinction of modem connections and voice connections. Unlike known solutions that use a frequency analysis of the signal the inventive solution relies on a logical evaluation of amplitude height values. Therefore the method primarily uses counting operations that can be implemented on a microcontroller. The usage of a DSP is advantageous. In that case it is possible to use a single DSP for multiple network termination units.

The modem detection method can be combined with the transformation method. Therefore the control unit can be used for both methods.

The invention furthermore comprises an apparatus that implements the transformation method.

The apparatus can contain a means to store a mapping. The values that can be written to the memory are the values by which the amplitude height values are replaced. The means may be a look-up table.

The mapping can be created and also modified by a multiplication of the predefined amplitude height values with a factor. Furthermore the apparatus may contain a means to store the constellation. The means can comprise at least six segments where each segment has sufficient capacity to store at least those amplitude height values of a constellation that contains at least three amplitude height values with the following property: the discernable amplitude difference deviates less than 25% from the respectively previous amplitude height value.

According to the invention the constellation can be used to determine the factor. In this case the apparatus comprise:

a) means to determine the smallest amplitude level that the data communication unit can discern

b) means to determine the greatest amplitude level for which the UCODE distance to the next greater amplitude level fulfils a predefined condition

c) means to determine the difference in amplitude between the determined greatest amplitude level (b) and the determined smallest amplitude level (a)

d) means to count the number of amplitude levels between the greatest and the smallest amplitude level of the constellation reduced by one

e) means to determine the quotient of the amplitude difference (c) and the reduced number (d)

f) means to multiply the predefined factor with the quotient (e).

The invented apparatus can be designed for installation in a linecard of a telecommunication network.

The invented apparatus can comprise control elements, in particular microcontrollers or digital signal processors.

The invented apparatus for detection of a modem connection by inspection of a signal comprises:

a) means for checking whether the signal shows amplitude height values corresponding to a silence period between 70 and 80 milliseconds

b) means for checking whether the signal following the silence period represents a predefined characteristic signal of a PCM modem

c) means to output a modem detect signal.

The apparatus may furthermore comprise means to store at least 10 amplitude height values, in particular a ring buffer.

The apparatus may recognize a sequence of ten amplitude height values P1, . . . , P10, followed by a the same sequence with negated sign −P1, . . . , −P10 as a characteristic signal.

The apparatus may recognize a sequence of six values of which three represent the same positive amplitude height value and three represent the same negative amplitude height value as a characteristic signal.

The apparatus may recognize a sequence of the amplitude values P, 0, P, −P, 0, −P with 0 being the smallest valid amplitude level and P being any other valid amplitude level as a characteristic signal.

The apparatus may designed in such a way that during modem detection amplitude levels that deviate by up to two steps from the expected amplitude level P are associated with P.

The invented apparatus for signal transformation favorably contains a modem detection unit, in particular the apparatus for modem detection as described.

One or all of the invented apparatuses can be comprised in a codec device or a network termination unit.

The invention shall be illustrated by examples in conjunction with the drawings. These drawings show:

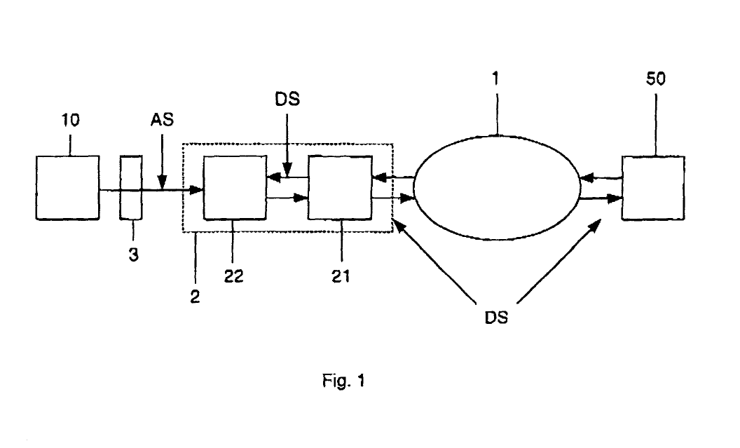

FIG. 1: a network termination unit of a PSTN,

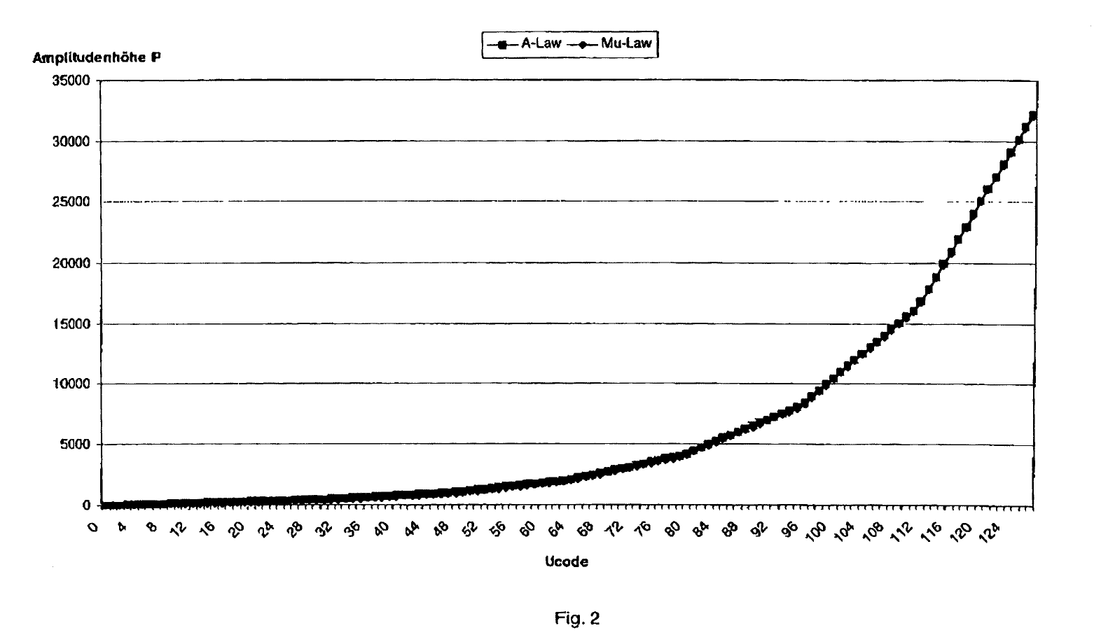

FIG. 2: a logarithmic characteristic according to ITU-G.711,

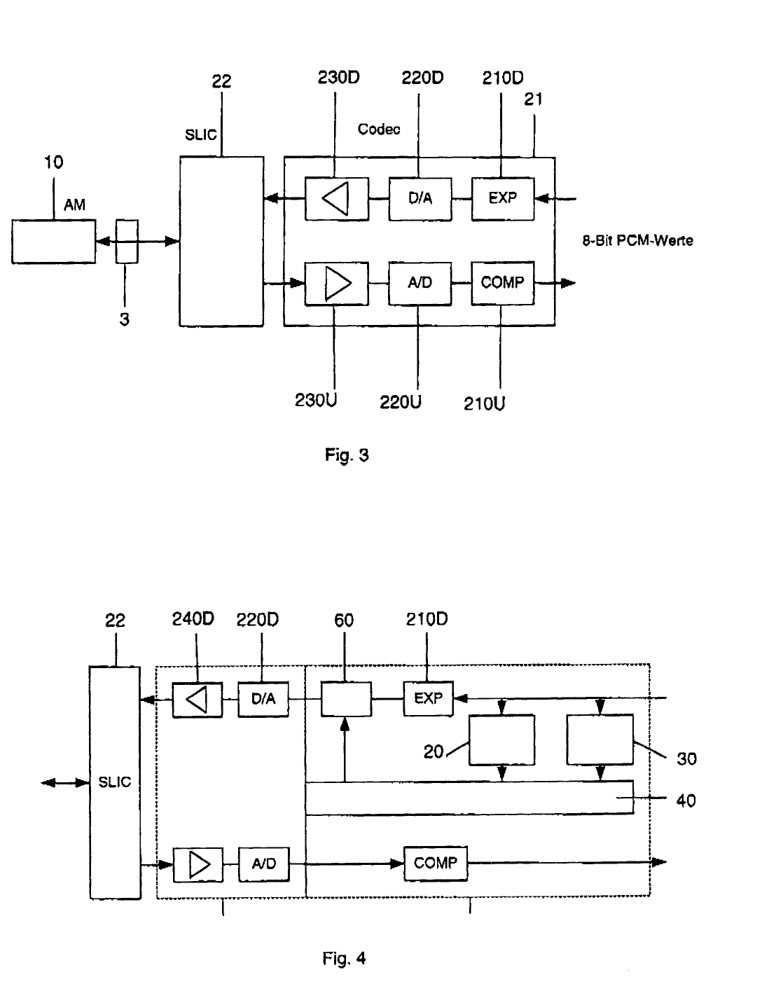

FIG. 3: a codec device according to the state-of-the-art,

FIG. 4: a network termination unit containing an inventive apparatus,

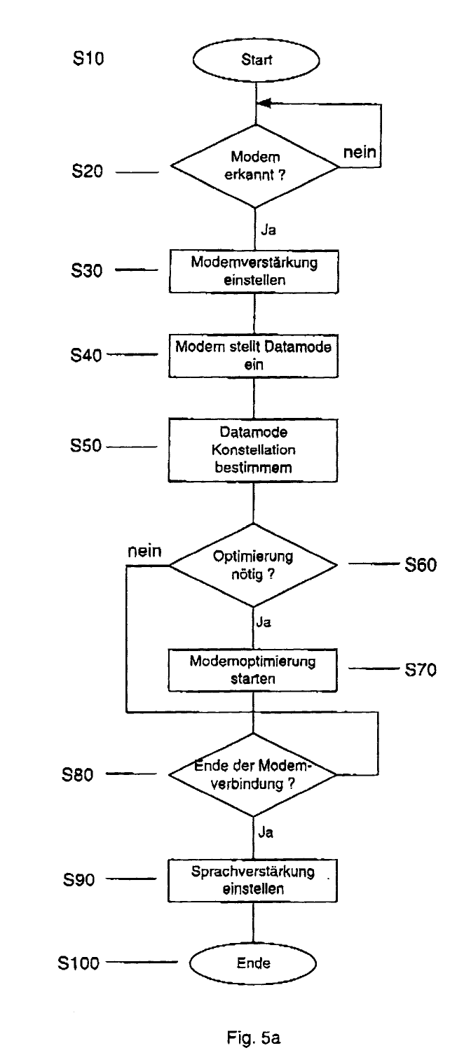

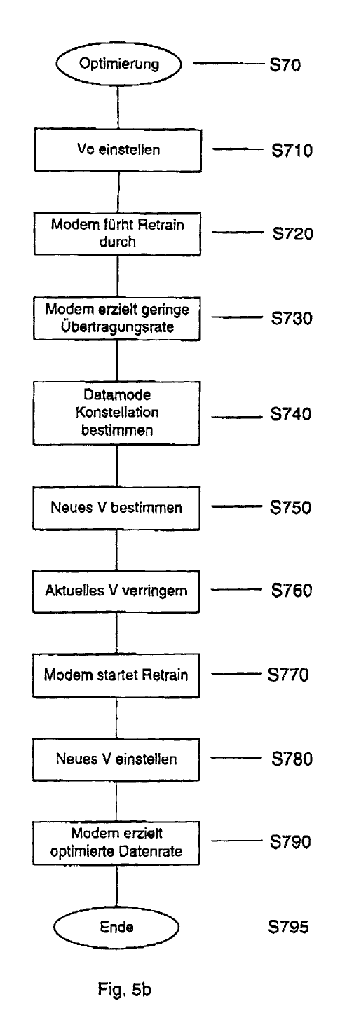

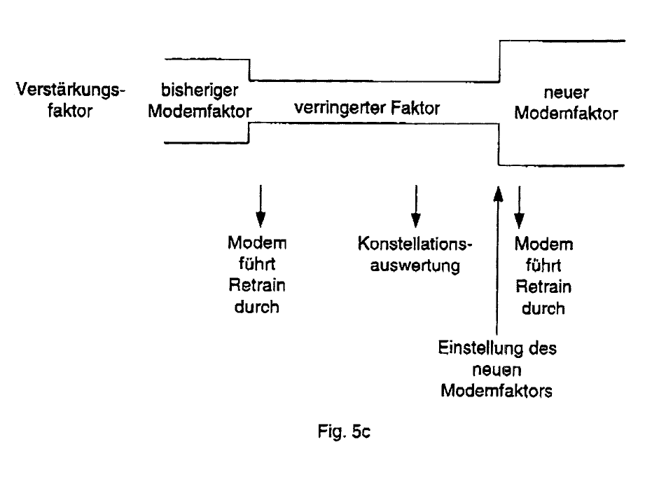

FIG. 5: an outline of the invented methods,

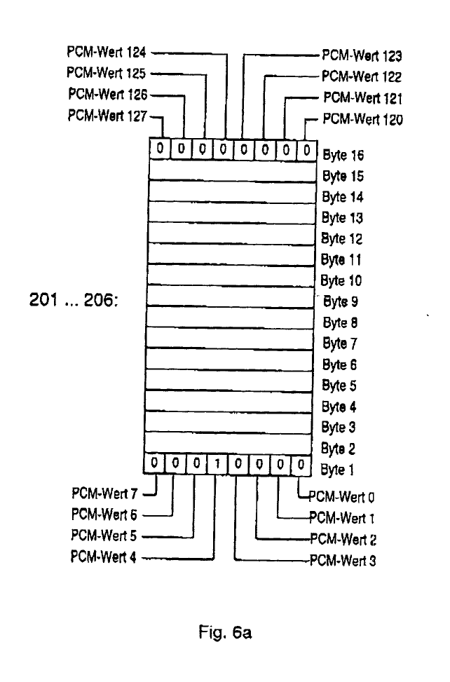

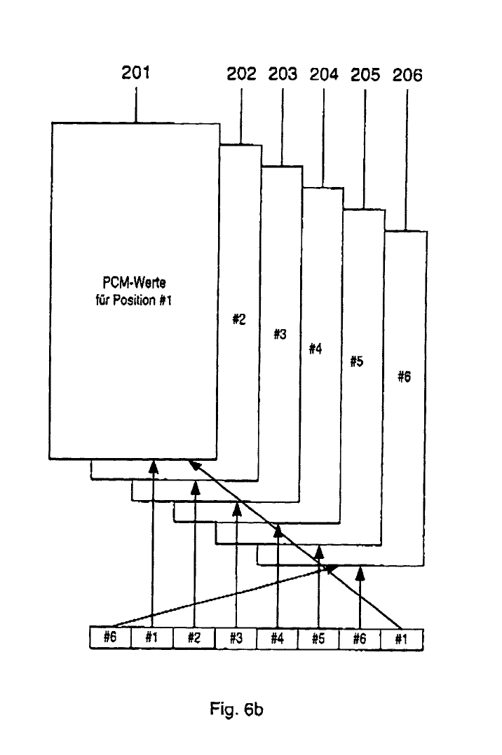

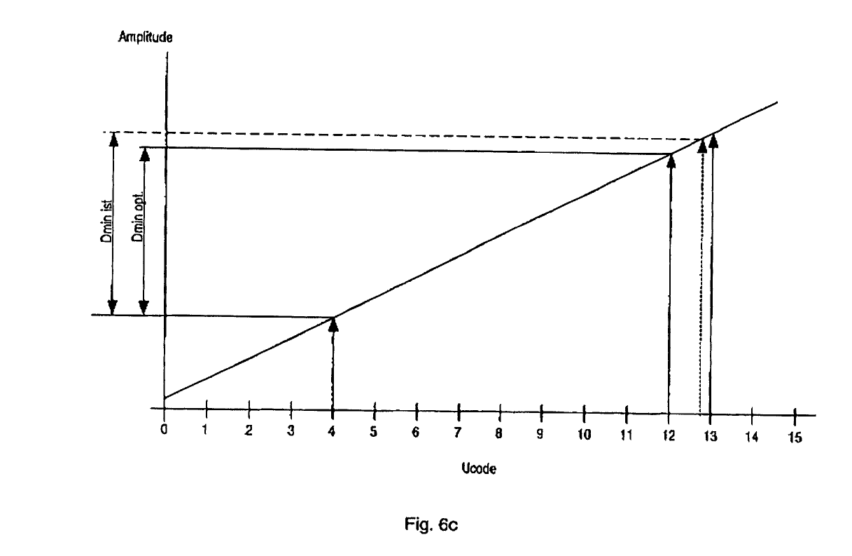

FIG. 6: composition and functionality of the apparatus for analyzation of the constellation,

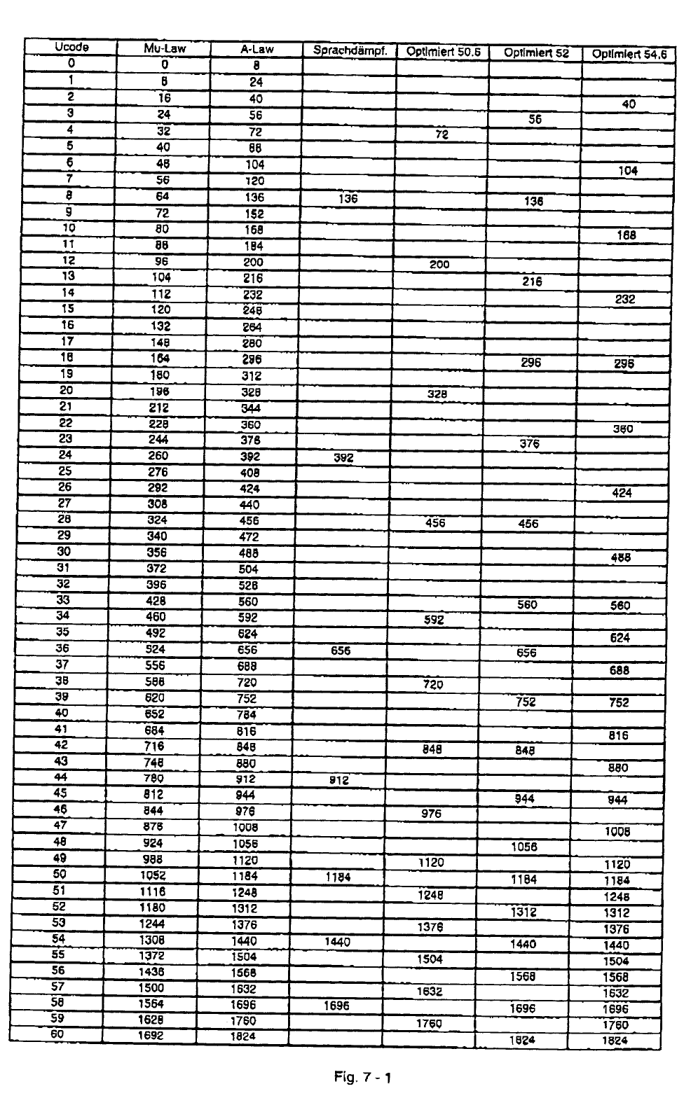

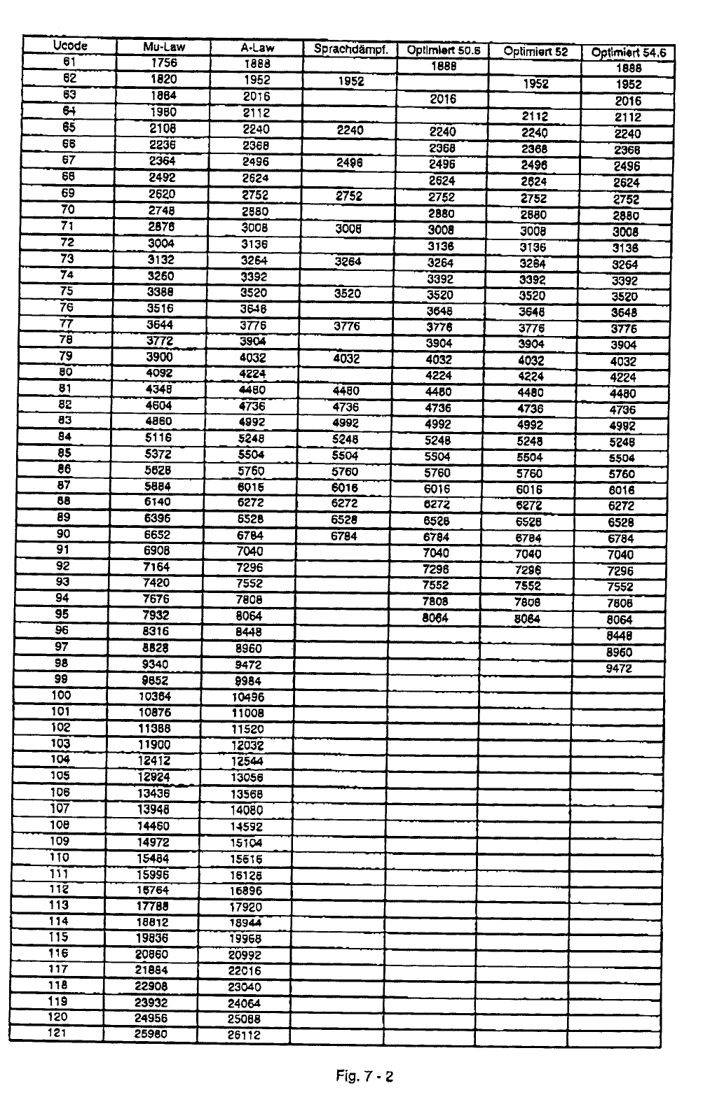

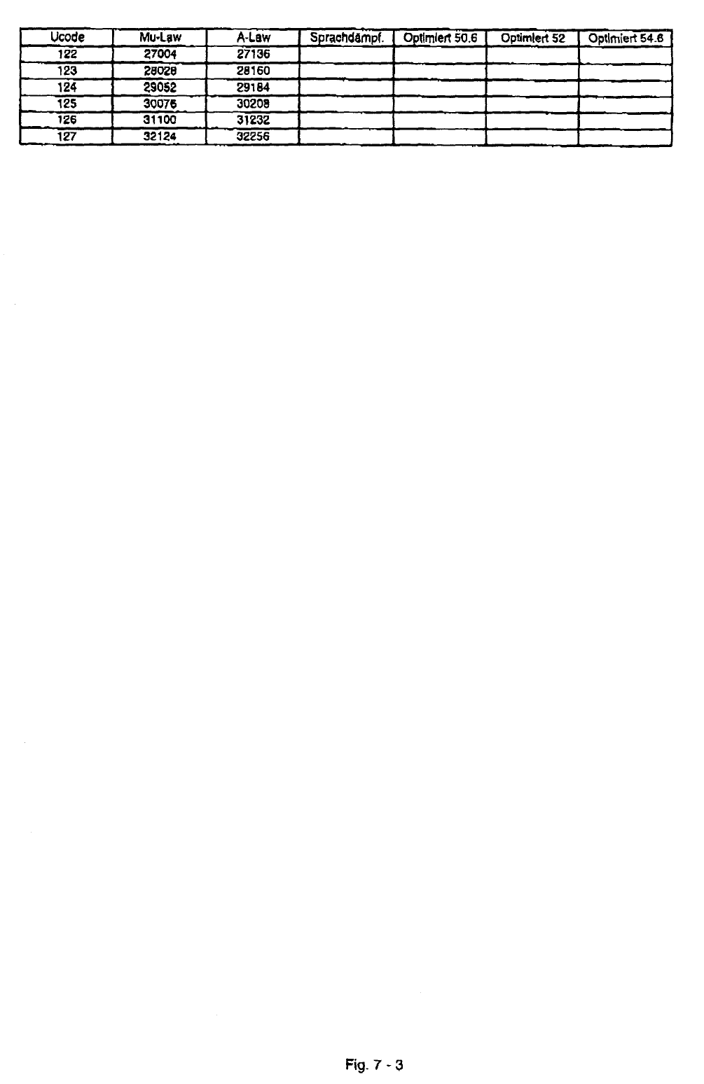

FIG. 7: examples of constellations,

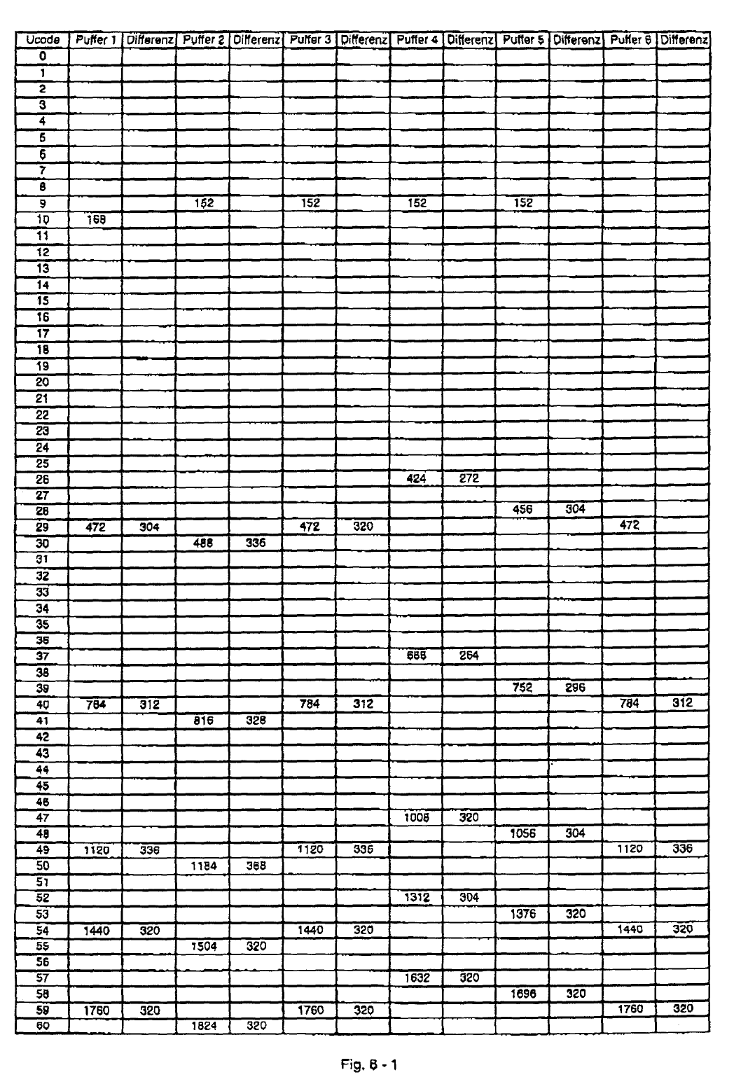

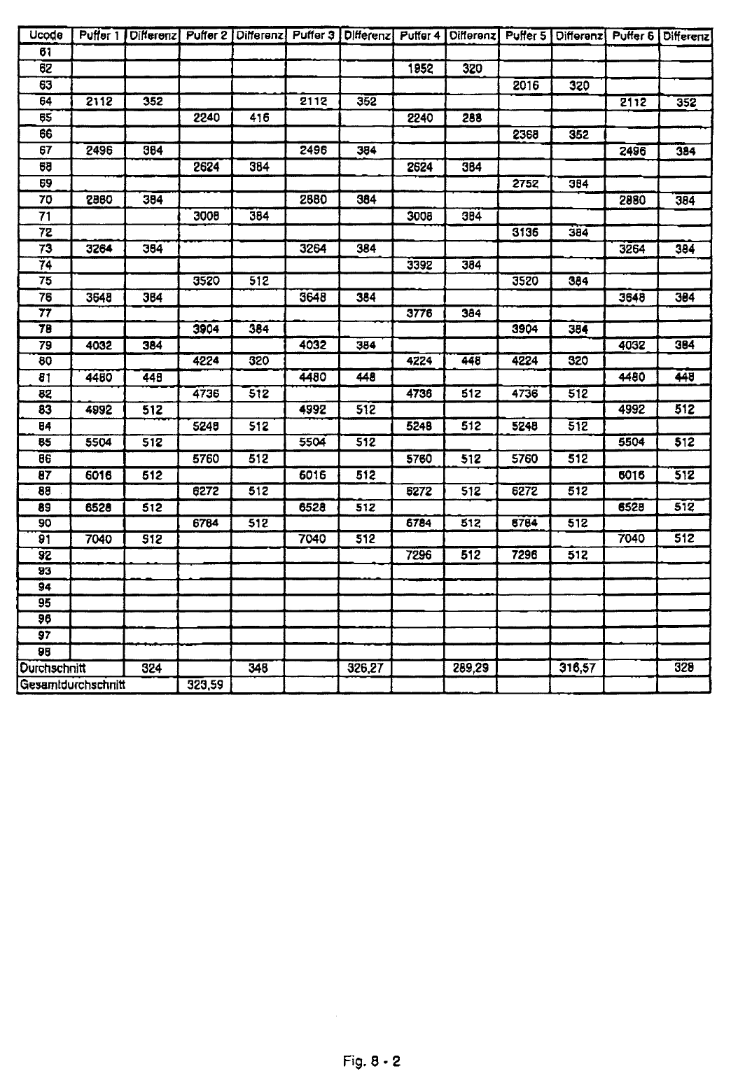

FIG. 8: example for a constellation table for a small gain factor,

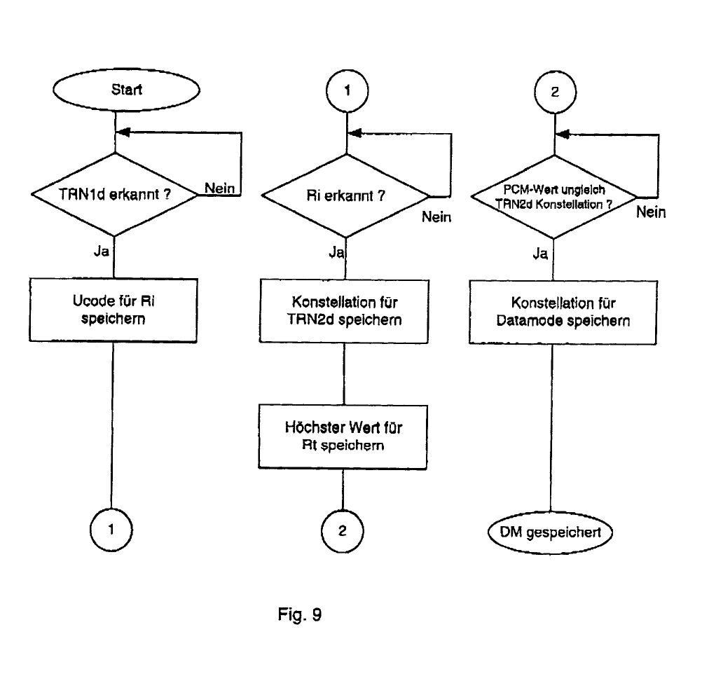

FIG. 9: a flow diagram for the method to determine the constellation,

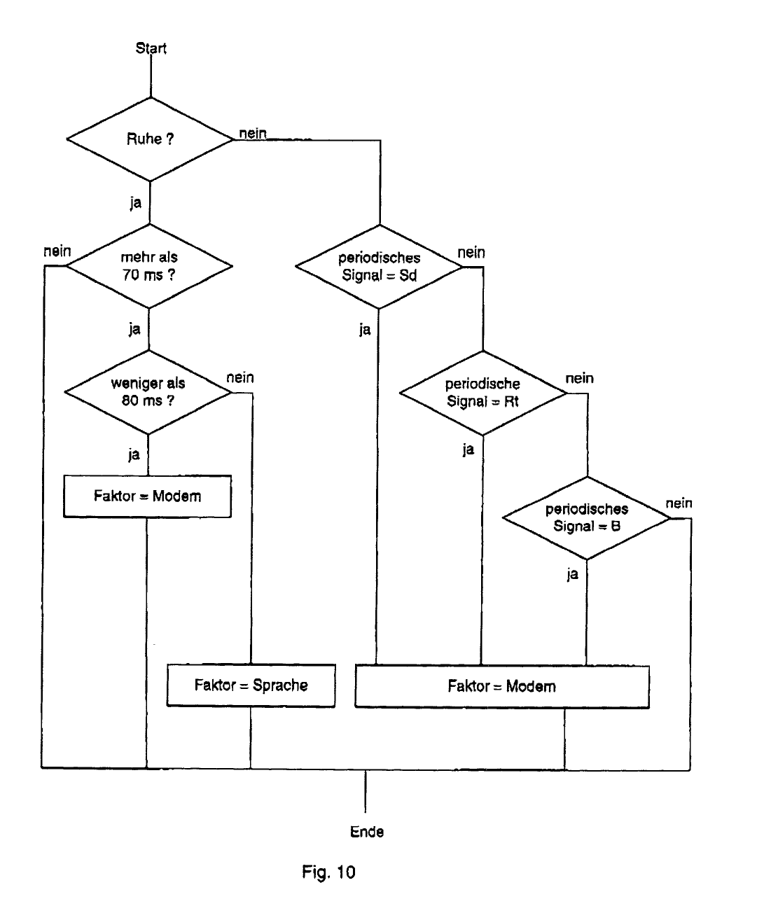

FIG. 10: a flow diagram for the method to detect a modem connection,

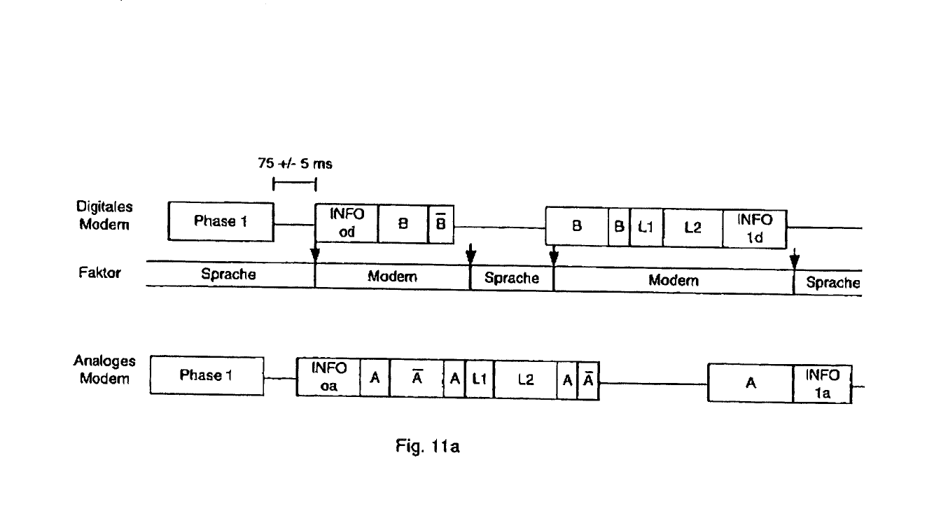

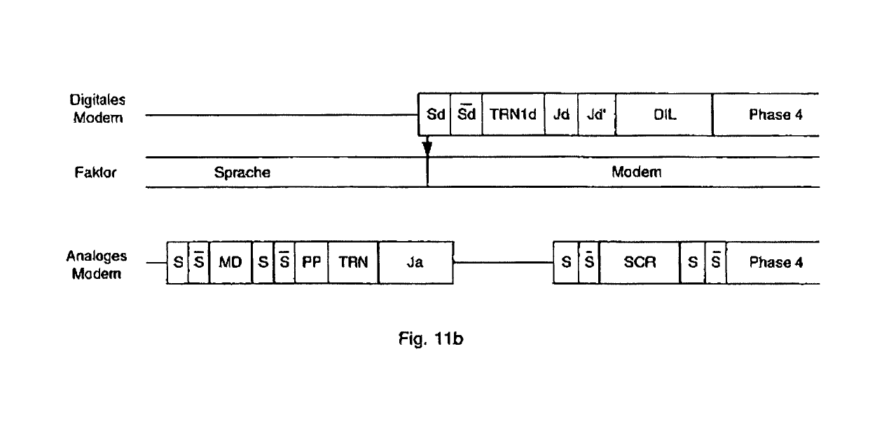

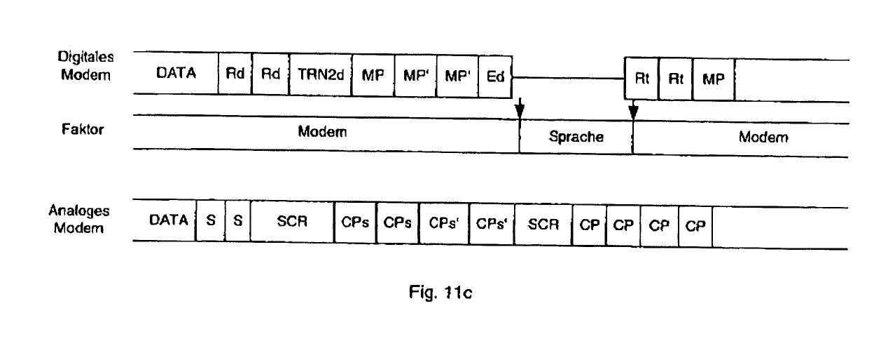

FIG. 11: a timing diagram for the modem detection and the adjustment of the attenuation factor,

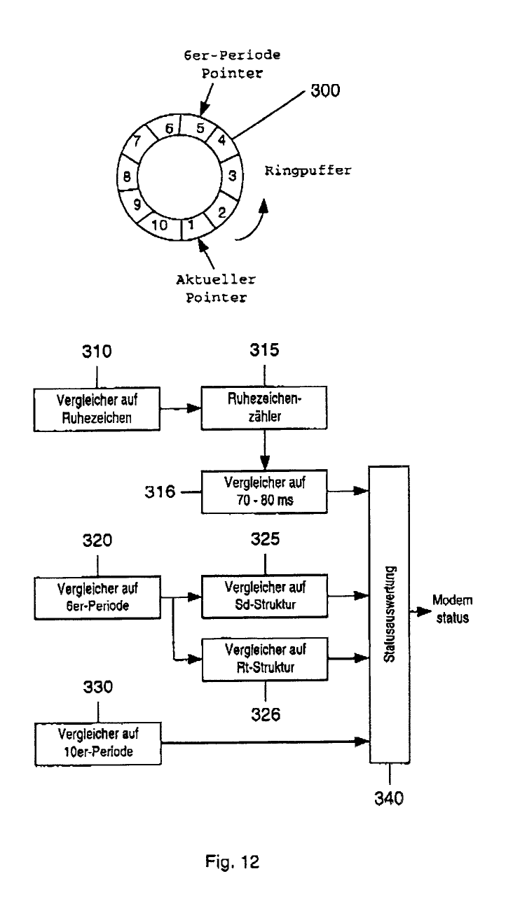

FIG. 12: schematics for a hardware implementation of an apparatus for modem detection, and

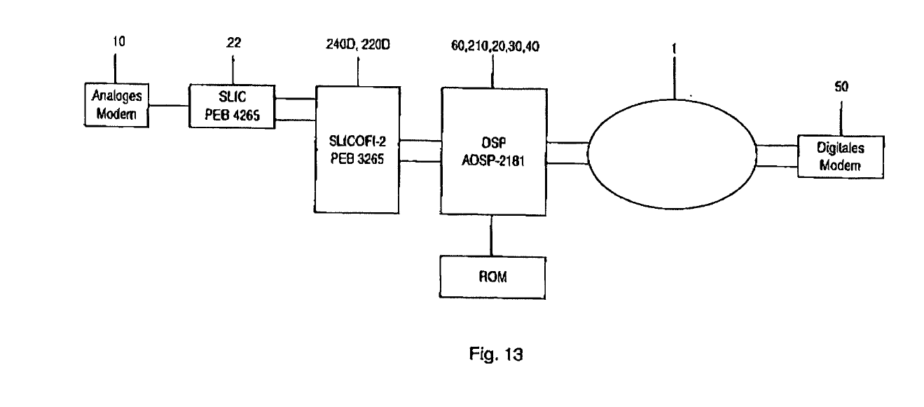

FIG. 13: schematics for a hardware implementation of the invented apparatuses

FIG. 1 shows a network termination unit (2) connected to the digital part of a telephone network (1). On one side a digital modem (50) is connected digitally, on the other side a PCM modem (10) is connected at an analog subscribers interface (3). The signal DS carried by the digital telephone network is pulse code modulated where only discrete values, called PCM values, are permissible. The permissible PCM values adhere to a logarithmic characteristic.

These values are specified by ITU recommendation G.711. The PCM values correspond to amplitude height values of an analog signal AS. Within the network termination unit (2) the digital signal DS is converted to the analog signal AS before it is transmitted to the subscriber line interface (3) where the analog equipment (10) is connected.

FIG. 2 shows a logarithmic characteristic according to ITU G.711. The PCM values on the y axis are defined by their UCODE number from 0 to 127 on the x axis.

The conventional network termination unit (2) comprises a codec device (21) and a SLIC device (22). As shown in FIG. 3 the codec device (21) comprises an expander (210D) and an D/A-converter (220D). The expander converts the digital signal with logarithmic characteristic into a digital signal with linear characteristic. The D/A converters converts the digital signal with linear characteristic into an analog signal AS. The amplifier 230D with constant gain implements the predefined attenuation. The SLIC device (22) converts the 4-wire signal into a 2-wire signal.

The signal conversion in the opposite direction is done by the amplifier 230U, the A/D-converter 220U and the compander 210U.

In the implementation example shown in FIG. 4 the invented apparatuses for signal transformation (60), analyzation of the constellation (20) and for detection of a modem connection (30) are integrated into the network termination unit.

The apparatus (60) is implemented as a digital multiplier with adjustable gain factor V. A unit (40) controls the apparatuses (20), (30) and (60). The modem detection apparatus (30) receives as an input the digital signal DS. If a modem connection is detected, i.e. a digital modem (50) on the other end of the connection, then apparatuses (20) and (60) are activated. Otherwise the predefined gain (attenuation) for voice calls remain in effect.

The digital signal DS is amplified (or attenuated) in the network termination unit in such a way that a maximal or predefined number of PCM values according to G.711 can be used in case of a modem connection. By this procedure it is possible to either maximize or exactly adjust the data rate between a digital modem (50) and the PCM modem (10).

According to the invention the optimal gain factor can be determined by analyzation of the constellation of the transmitted signals. For this a constellation analyzation unit (20) is used.

FIGS. 5 a,b,c outline the inventive methods. After the communication has started (S10) the modem detection (S20) is applied. If a modem connection is detected then a gain factor V for modem connection is applied (S30). The modem proceeds to data mode and starts with the transmission of data (S40). Now the data mode constellation is analyzed and the current data transfer rate is calculated by the invented method (S50). If the data rate is already optimal with respect to the predefined criterion (S60) then the currently used gain factor V remains in effect until the end of the connection is detected (S80). At this point the gain factor V for voice calls is applied (S90) and the process terminates (S100).

If in step (S60) the data rate has been found to be not optimal then the invented method for signal transformation is started (S70). At first a small gain factor V0 is applied in step (S710).

The modem starts a retrain to adjust the constellation accordingly (S720). With the now reduced data rate the data transfer continues (S730) from the digital modem (50) to the analog modem (10) (S370).

According to the invented method the new constellation is determined and analyzed (S740) and the optimal gain factor V according to the predefined criterion is calculated (S750). This factor is, however, not applied immediately. Instead the currently used gain factor V0 is decreased again (S760) to provoke another retrain of the modem (S770). At the start of the retrain the calculated gain factor V is applied (S780) and thus the modem adapts the new constellation to this factor. This procedure results in the optimal or predefined data rate (S790). The connection then continues with (S80).

According to steps (S710) to (S780) it becomes apparent that in order to achieve a predefined data rate the gain of the amplified is changed. For calculation of the gain changes the constellation of a modem connection at a very low gain V0 is analyzed. This increases the accuracy of the determination of the optimal gain factor V. The optimal factor V is applied subsequently, i.e. after the gain factor V0 has been reduced temporarily as illustrated by FIG. 5c.

FIGS. 6a to c show the functionality and the composition of the invented apparatus for constellation analysis. (20). The task of the apparatus (20) is to determine the UCODE-values the digital modem uses currently. For this purpose a buffer memory (201) is used where every used value is marked. As an example a memory of 16 bytes can be used (FIG. 6a). Every bit of a byte corresponds to a value. In this case the eight bits of the first byte correspond to the smallest eight values. The eight bits of the second byte correspond to the following values and so on. Important is only the non-ambiguous correlation of a memory element to specific value. Because V.90 allows up to six different constellations it is favorable to have six buffers (201-206). This requires in total 96 bytes (FIG. 6b).

The apparatus for constellation analysis (20) is activated by the beginning of the data mode phase. In this case the constellation gets determined by setting the bit in memory that correspond to the values currently sent. This procedure must be repeated for a period that is long enough that statistically all values used in a constellation have occurred at least once. As an example 4000 samples can be taken.

The optimal gain factor V (according to the characteristic G.711) is the factor at which the minimal amplitude difference that the PCM modem (10) can discern is exactly the difference between two adjacent values in the same segment (FIG. 6c, Dmin opt). In this case all 16 values of this segment as well as in all higher segments can be used. As according to G.711 the difference is halved in the next lower segment only every second value can be used in that segment. Accordingly in the next lower segment only every fourth, then every eight and finally only every 16^{th} value can be used.

If the uLaw characteristic (according to G.711) is used this results in 1 usable value in the first segment, 2 usable values in the second segment, 4 usable values in the third segment, 8 usable values in the fourth segment and 16 usable values in the fifth segment. Starting with the sixth segment all values can be used. In the sixth segment the amplitude difference of the available values is twice as large as the minimal required difference, in the seventh segment it is four times as large and in the eighth segment it is eight times as large.

If the Alaw characteristic (according to G.711) is used then the distribution is different within the first segment because the amplitude difference of the values is the same for the first two segments and therefore 2 values are usable in each segment. In the third segment 4 values are usable, 8 in the fourth segment and 16 in the fifth segment. If it is possible to use larger values then automatically the values in the sixth segment differ by twice the minimal required distance, in the seventh segment the values differ by four times the minimal required distance and in the eighth segment the values differ by eight times the minimal required distance.

If the minimal difference Dmin is greater than the amplitude difference of the values as described in the distribution described above then this results in a smaller number of usable values (refer to FIG. 6c, Dmin ist). When analyzing the constellation one must bear in mind that the maximum number of used values may be limited by a maximum signal power of the sent signal. A typical power limit is −12 dB.

As an example with the Alaw characteristic, a distance Dmin of 8 values in the lowest segment an the power limit n=46 values shall be usable. This results in a data rate of 52000 bit/s of which 50677 remain for the user. If the next higher user data rate of 52000 bit/s shall be reached according to V.90 the number of usable values must be increased to n=51. This can be achieved if Dmin is reduced to 80. At a minimal distance Dmin of 64 the number of usable values is n=66. With this value a data rate of 56000 bit/s of which 54667 bit/s remain for the user is achieved.

According to the invention the gain factor V for apparatus (60) is calculated in such a way that with the given conditions one of the aforementioned numbers n is matched best. For this purpose first of all the smallest discernable amplitude difference is determined. In a first step the gain factor is reduced to a value V0 that allows a sufficient resolution by calculation of an average value across several amplitude height values. This is the case if the discernable amplitude difference deviates less than 25% from the two previous amplitude height values.

The reduced gain factor V0 is chosen in such a way that at least 3 amplitude height values fulfill the condition. If the used amplitude height values of the six possible constellations turn out to be different then the average of the six values is calculated.

The amplitude difference is then used to calculate the new, optimal gain factor V. For this purpose the amplitude difference is divided by 128, 80 and 64 and then multiplied with the reduced gain factor. It is checked which of the three results is closest to the gain factor 1. This result is then used as the new gain factor V for the modem connection.

The change of the gain factor V to a smaller value V0 can be done without preparation. This leads to a retrain of the modems (10) and (50). The change of the gain factor V to a greater value is favorably preceded by a change to a smaller factor. Only when the start of the retrain is detected (silence period of 75+/−5 ms) the change to the greater factor happens. If the gain factor would be changed towards the greater value immediately then it is possible that a retrain request by the digital modem (50) might not be detectable any more and the connection would be aborted.

With reference to the tables of FIG. 7 and FIG. 8 an example for the inventive calculation of the gain factor V shall be given. The table of FIG. 7 shows all PCM values (amplitude height values) according to G.711 for a given gain factor V. The first column contains the UCODE number of the value. Column 2 and 3 defined the amplitude height value according to the uLaw or Alaw characteristic.

Column 4 shows the values used by a constellation which a modem (10) has chosen for the predefined gain value V for voice calls.

In the table shown by FIG. 8 six constellations are given. These constellations have been chosen with a reduced gain factor V0 of 16/128 in effect. This is equivalent to an attenuation of −18 dB. During the data mode phase the constellation analysis apparatus (20) has therefore stored the following constellation data in the buffer memories 1 to 6:

1. buffer: 10,29,40,49,54,59,64,67,70,73,76,79,81,83,85,87,89,91

2. buffer: 9,30,41,50,55,60,65,68,71,75,78,80,82,84,86,88,90

3. buffer: 9,29,40,49,54,59,64,67,70,73,76,79,81,83,85,87,89,91

4. buffer: 9,26,37,47,52,57,62,65,68,71,74,77,80,82,84,86,88,90,92

5. buffer: 9,28,39,48,53,58,63,66,69,72,75,78,80,82,84,86,88,90,92

6. buffer: 29,40,49,54,59,64,67,70,73,76,79,81,83,85,87,89,91.

For the constellation stored in the first buffer the following amplitude differences result (amplitude height values according to FIG. 8): 472−168=304, 784−472=312, 1120−784=336, 1440−1120=320, 1760−1440=320, 2112−1760=352, 2496−2112=384. The last value does not meet the requirement 304*1.25=380 and is therefore not used. The average value of the first six differences is 1944/6=324.

Optionally, e.g. if the stored constellations differ considerably, the amplitude difference of the remaining five buffers can be calculated the same way. Subsequently the average value of the resulting differences is calculated. In this examples the average value of all six constellations is 324 (rounded).

The optimal gain factor V can now be calculated by dividing the average value by the target amplitude difference and multiplying the result with the reduced gain factor V0. According to this formula the result for the three optimal target constellations is:

324/64*16=81

324/80*16=64.8

324/128*16=40.5

Depending on the criterion for the optimization (i.e. the target data rate) the new gain factor is chosen. If the criterion is the highest possible data rate, that is a maximum number of usable amplitude height values), then the factor is 81/128. If the target data rate is 52000 (50677) bit/s then the factor is 64.8/128 (40.5/128). FIG. 7 shows the optimal constellations that result in the target data rates. The right columns show that the optimized data rate (as opposed to the normal data rate) is actually achieved.

If other data rates shall be achieved then first their corresponding minimal amplitude difference with respect to the available amplitude height values is calculated and then this difference is used as the target amplitude difference in the calculation of the optimal gain factor.

Furthermore it is favorable to set the gain factor V to a value in between the calculated optimal value and the value corresponding to the next higher data rate. It has been found that a value closer to the upper limit leads to an increased signal-to-noise ratio while a value closer to the lower limit (up to 5% above the calculated value) leads to a more stable data connection. In the example one would therefore use 84 instead of 81 (42 instead of 40.5) for the latter case.

A preferred embodiment of apparatus (60) is a digital multiplier. Every used amplitude height value is multiplied with the same gain factor V. The gain is therefore linear. It can be, however, be implemented with some inaccuracy, e.g. by pruning the least significant bit. Another preferred embodiment is a look-up table. The table is indexed by the amplitude values. Each entry contains the corresponding amplitude value multiplied with the gain factor. Therefore during data transmission the amplitude value is simply replaced by the table entry. This avoids the permanent calculation of the amplitude height values.

The amplifier (60) can also amplify the analog signal. In this case it is located after the D/A conversion but still on the 4-wire line before the SLIC device (22). In this case it is implemented as an adjustable analog amplifier.

The control unit (40) is used for control of the amplification. It can be implemented as a microcontroller.

The data mode differs from the preceding training mode with respect to the constellation used. Therefore other amplitude height values are used. The inventive determination of the constellation used in data mode is done by looking for the characteristic signal with pattern “R”. This is a pattern with the sign bit sequence +++−−−. FIG. 9 shows a flow diagram for this procedure. FIG. 11 is also referred for signal names. The amplitude height values can be different, however they are known always from the preceding signals. Signal Ri uses the same UCODE for all six PCM values. This UCODE is the same that has been used during signal TRN1d. This UCODE is therefore known by storing it during TRN1d. Signal Rd uses the highest values of each constellation. Therefore at most six different values can be used. These values are known from the constellation determination during data mode. It is the highest value of each constellation table. Signal Rt has the same property as signal Rd with the difference that this time the highest values of the training constellation are used. In order to determine these values the constellation used during signal TRN2d is analyzed and the highest values that occur are stored.

The start of signal TRN2d is determined by the end of signal Ri. The start of the data mode is detected if a value occurs that is not an element of the training constellation. As soon as data mode has been detected storing of the constellation data starts. After a preset number of samples the constellation is analyzed.

The apparatus (20) is fed by new PCM values. The same values are also fed in parallel to the TRN1d-detector, the Ri-detector, the TRN2d-detector and the data mode constellation detector.

The TRN1d-detector checks the signal for the occurrence of signal TRN1d during transmission. If the signal occurs then the used amplitude height value is stored as a reference for the Ri detection. The Ri-detector checks the signal for the occurrence of signal R1 during transmission. The TRN2d detector discerns the TRN2d signal from the Ri signal.

The data mode constellation detector discerns the data mode signal from the TRN2d signal. It stores the used PCM values.

The Dmin/V calculation logic determines the amplitude differences to be used and the number of the used PCM values. According to the chosen criterion it calculates the new gain factor V. The control unit triggers the Dmin/V calculation logic.

Furthermore a method or apparatus to detect a modem connection is implemented to discern a modem connection from a voice call. FIG. 10 shows a flow diagram for the inventive detection of a modem connection.

The invented method exploits the fact that the digital modem (50) works synchronously to the 8 kHz clock of the telephone network. This results in a period sequence of 20 PCM values for the 2400 Hz tone (Tone B). The second 10 PCM values repeat the first 10 PCM values with negated sign. Tone B can exhibit an attack. In this case the periodic sequence is delayed by some time. Furthermore all other signals of a V.90 connection that occur after a silence period are periodic with a repeating sequence of 6 PCM values. As a result the shown procedure gets called for every PCM value.

In a first step the incoming digital signal is checked for the occurrence of a silence period with a duration in between 70 and 80 ms. During this silence period the signal amplitude must be either the lowest or the next lowest valid value. If this is the case then a modem connection is present. If the duration of the silence period exceeds 80 ms then a voice call is present.

If it is not a silence period then checks are done for other signals characteristic for a modem connection.

A periodic sequence of 20 PCM values where the second 10 PCM values represent the first 10 values with negated sign is regarded as a characteristic signal.

Furthermore a periodic sequence of three positive and three negative amplitude height values with identical absolute values is regarded as a signal characteristic for a modem connection.

A periodic sequence with the amplitude height values P, 0, P, −P, 0, −P is also regarded as a haracteristic signal if 0 represents the smallest valid value and P any other valid value, positive ore negative.

The procedure shown in FIG. 10 first checks whether the PCM value (i.e. the amplitude height value) represents silence. If so it is checked whether a duration in between 70 and 80 ms has occurred. If so a modem connection is detected and the gain factor V of the amplifier is set to its initial value. If the duration exceeds 80 ms then it is a voice call and the gain factor V is set to a predefined value (e.g. 7 dB).

If the next value does not represent silence then checks are done for signals Sd, Rt or Tone B. If one of these signals is detected then a modem connection is detected and the gain factor V is set accordingly. Otherwise the gain factor V for a voice call is set.

The timing is explained with reference to FIGS. 11a to c. After phase 1 (FIG. 11a) a silence period of 75+/5 ms happens. The gain factor V for a modem connection is set. During the probing phase the digital modem does not send a signal for some time. In this case a silence period exceeding 80 ms is detected and therefore the gain factor for voice calls is set. When Tone B is sent by the digital modem the periodic sequence of 10 values (without sign) or 20 values (with sign) is detected after an attack period. At this point the gain factor is again set for a modem connection. At the end of the probing phase the digital modem again sends silence for an extended period before phase 3 of the digital modem starts (FIG. 11b). As a result the gain factor for voice calls is set again. The first signal sent after the silence period is signal Sd which is a sequence of 6 amplitude height values. As soon as these are recognized the gain factor is set again for a modem connection. From this point on the digital modem always sends a data signal and therefore the gain factor for modem connection remains set.

A special case is the so-called “Rate Renegotiation with Silence Period”. Here the digital modem transmits silence to enable the training of the echo canceller of the analog modem. Because of this silence period the gain factor for voice calls is set again. The signal following the silence period is defined to be Rt. This signal comprises a periodic sequence of 6 amplitude height values. Once the signal is detected the gain factor V for modem connections is set again.

In a preferred embodiment of the modem detection apparatus a deviation of up to two values adjacent to the values looked for are accepted as the value looked for. This results in a more robust detection of modem signals even in the presence of somewhat varying digital signals.

Depending on the implementation of the PCM modem on the analog side it may be necessary to make the change of the gain factor for modem connections synchronously with the transmission of signals B, R and Sd. This ensures that even with modems that are sensitive to phase changes during the transmission of the characteristic signals the target data rate can be achieved.

As the modem detection works with simple counting operations on amplitude height values a digital signal processor is not generally required.

In the example the inventive modem detection apparatus is coupled with the amplification unit. The gain factor V used for modem connection is then used as the initial value V which is modified over time. In this case both units can be controlled by a common control unit (40).

FIG. 12 shows schematics for a hardware embodiment of the apparatus for modem detection. The apparatus comprises a ring buffer or memory (300) that stores the most recent PCM values and comparators for silence values, periodic sequences of 6 values and comparators for periodic sequences of 10 values.

In the example a ring buffer (300) for 10 elements is used. The number 10 has been chosen because then the write pointer and the read pointer for checking for periodic signals comprising sequences of 10 PCM values are identical. The size of the ring buffer may be enlarged but then two pointers are required.

A subsequent PCM value of the digital signal DS is fed to the comparators (310) (320) and (330) which compare for silence values, periodic signals comprising 10 values and periodic signals comprising 6 values. The comparators (310), (320) and (330) compare the subsequent PCM value with the values read from ring buffer (300). According to the result of the silence comparator (310) the silence counter (315) is incremented. The counter is compared to the valid window. The comparators (320) and (330) for periodic signals check whether the respective period is given. For the signals with period 6 it is also checked whether the PCM value is the one expected for signal Sd or signal Rt. For this purpose the two additional comparators (325) and (326) augment comparator (320). The result of the comparators (320) and (330) for periodic signals are fed to the status evaluator (340). The status evaluator (340) combines the results of the comparators (320) (330) into a signal that indicates the presence of a modem connection and that can be used to switch the gain factor accordingly.

Finally the subsequent PCM value is stored at the location indicated by the write pointer into the ring buffer (300) and the pointers are advanced by one position.

The apparatus (30) for modem detection can also be implemented by a programmable control unit (microprocessor, DSP) where a program steps through stores and comparisons. In this case the ring buffer (300) may be part of the available memory.

FIG. 13 shows a hardware implementation of the invented apparatuses. Any commercial analog modem (10) can be used. The SLIC device (22) can be a PEB4265 manufactured by Infineon Technologies. It is connected to the codec device PEB3265 which contains the A/D conversion and also the driver for the SLIC (240D), (220D). The adjustable gain factor of amplifier (240D) is initially set to e.g. 0 dB. The digital signals for the codec device are generated by the ADSP2181 manufactured by Analog Devices (units (60), (210), (20), (30) and (40)) and are transmitted by a first serial interface. The second serial interface of the ADSP-2181 is connected digitally to the telephone network (1). As a sender a digital modem (50) is connected.

Further embodiments may contain means to set the criterion for the number of amplitude height values in order to achieve a given data rate. The criterion can be set from a central side, e.g. by the Telco.

The invented methods for calculation of the optimal gain factor from the used constellation are also applicable for communication of other equipment, e.g. fax devices ode modem-to-modem connections.

What is claimed is:

1. A method for transforming a signal (DS) on a four-wire line which comprises discrete amplitude height values (P1, . . . , Pn) for conversion into a corresponding analog signal (AS) with amplitude height values (A1, . . . , An) on a two-wire line where said analog signal (AS) is intended for a data communication unit connectable to the two-wire line and where said data communication unit has a predefined capability for resolution of the amplitude of said analog signal (AS) and said method being determined by: said amplitude height values (P1, . . . , Pn) of signal DS on the four-wire line are each transformed by application of a transformation (T) where said transformation is determined in such a way that the number (n) of said amplitude height values (A1, . . . , An) which said communication unit can discern in said analog signal (AS) matches a presetable criterion (K).

2. A method according to claim 1, wherein said criterion (K) is a maximum number (n) of discernable amplitude height values.

3. A method according to claim 1, wherein said criterion is a preset range of said number (n).

4. A method according to one of the previous claims, wherein said transformation (T) is a multiplication of said amplitude height values (P1, . . . , Pn) with a factor (V).

5. A method according to one of the previous claims, wherein said factor (V) is calculated by the determination of the constellation of said signal (DS).

6. A method according to one of the previous claims, wherein said factor (V) is calculated by the determination of the minimal difference (Dmin) of two amplitude height values (Ai, Aj) of said analog signal (AS) that said communication unit (10) can discern.

7. A method according to one of the previous claims, wherein said signal (DS) comprises amplitude height values (P1, . . . , Pn) according to a predefined characteristic, in particular a characteristic adhering to ITU recommendation G.711.

8. A method according to one of claims 4 to 7, wherein said factor V is calculated from the constellation of said signal (DS) where the amplitude height values (P1, . . . , Pn) are multiplied with a predefined small factor (V0), in particular a factor for which for at least three amplitude height values (Pc, Pf, Ph) the discernable amplitude difference deviates less than 25% from the respectively previous amplitude height value.

9. A method according to claim 8, further comprising for the calculation of said factor (V) the steps of:
a) determination of the smallest amplitude height value said data communication unit can discern (Amin);
b) determination of the largest amplitude height value (Amax) for whose corresponding universal code (UCODE) difference to the next larger amplitude height value a predefined condition is met;
c) calculation of the amplitude height difference (D) of said largest amplitude height value (Amax) and said smallest amplitude height value (Amin);
d) counting the number of amplitude height values in between the largest and the smallest amplitude height value of the constellation and reducing said number by 1;
e) calculation of the quotient (Q) of said amplitude height difference (D) and said reduced number;
f) multiplication of said predefined factor (V0) with said quotient (Q)

10. A method according to claim 9, wherein said predefined condition is “at least 4”.

11. A method according to claim 9 or 10, wherein in front of step (f) said factor (V0) is further reduced.

12. A method according to one of the previous claims, wherein said transformation is done by replacing each amplitude height value (P1, . . . , Pn) according to a mapping by a predefined amplitude height value.

13. A method according to claim 12, wherein the mapping is calculated by the multiplication of said amplitude height values (P1, . . . , Pn) with a predefined factor (V).

14. A method according to one of the previous claims, wherein said transformed amplitude height values (P1, . . . , Pn) exhibit a predefined accuracy, in particular at least 12 bit.

15. A method according to claims 1 to 11, wherein said signal (DS) is an analog signal.

16. A method according to one of the previous claims, wherein said communication unit (10) is a PCM modem and said signal (DS) originates form a digital modem (50).

17. A method to detect the presence of a modem connection from said signal (DS) comprising the steps of:
a) checking, whether said signal (DS) exhibits a silence period in the range of 70 to 80 ms and, if the signal amplitude matches a predefined low amplitude height value during said silence period, issuing a modem detect signal;
b) otherwise, if the silence period exceeds 80 ms, checking whether the signal following the silence period (DS) represents a predefined characteristic signal of a PCM modem and, if positive, issuing a modem detect signal.

18. A method according to claim 17, wherein a sequence of ten amplitude height values P1, . . . , P10, followed by the same sequence with negated sign −P1, . . . , −P10 is detected as said characteristic signal.

19. A method according to claim 18 wherein a periodic sequence of six amplitude height values comprising three constant positive values P and three constant negative values −P is detected as said characteristic signal.

20. A method according to claim 17, wherein a periodic sequence of the amplitude height values P, 0, P, −P, 0, −P with 0 being the smallest valid amplitude height value and P being any other valid amplitude height value is detected as said characteristic signal.

21. A method according to one of the claims 17 to 20, wherein for modem detection amplitude height values with a deviation of up to two levels from the amplitude height values required for detection are mapped to that amplitude height value.

22. A method according to claims 1 to 16 wherein as a first step a modem detection is performed, preferably according to a method as claimed in claims 16 to 20, and the following steps are only taken if a modem connection has been detected.

23. A method according to one of the previous claims implemented in a network termination unit.

24. An apparatus adapted for the implementation of the methods according to one of the previous claims.

25. An apparatus according to claim 24, wherein means for storing a mapping are provided, said means suitable for storing amplitude height values that replace said amplitude height values (P1, . . . , Pn) accordingly.

26. An apparatus according to claim 25, wherein said mapping is calculated by the multiplication of the predetermined amplitude height values with a factor (V).

27. An apparatus according to the previous claim, further comprising means to store the constellation.

28. An apparatus according to one of the claims 24 to 27, wherein said means for storage of said constellation comprise at least six memory segments where each segment has enough capacity to assign one memory element to at least those amplitude height values for which the discernable amplitude difference deviates less than 25% from the respectively previous amplitude height value.

29. An apparatus according to one of the previous claims referring to apparati, wherein an implementation in a network termination unit is intended.

30. An apparatus according to one of the previous claims referring to apparati, wherein the apparatus is activated at the start of a data communication between a transmission unit and said communication unit.

31. An apparatus according to one of the previous claims referring to apparati, wherein said communication unit (10) is an analog PCM modem and said signal (DS) is generated by a digital modem (50).

32. An apparatus according to one of the previous claims referring to apparati, further comprising a control unit (40), in particular a microcontroller or a digital signal processor.

33. An apparatus for detection of a modem connection from a signal (DS) comprising:
a) first means (310, 315, 316) to check whether said signal (DS) comprises amplitude height values corresponding to a silence period in between 70 and 80 ms;
b) second means (320, 325, 326, 330) to check whether said signal (DS) following said silence period is a predefined characteristic signal of a PCM modem;
c) means (340) for issuing a modem detect signal.

34. An apparatus according to claim 33, further comprising means (300), in particular a ring buffer, for storing at least 10 amplitude height values.

35. An apparatus according to claim 33 or 34, wherein a sequence often amplitude height values P1, . . . , P10, followed by the same sequence with negated sign −P1, . . . , −P10 is detected as said characteristic signal.

36. An apparatus according to one of the claims 33 to 35, wherein said second means (320, 325, 326, 330) are implemented in such a way that a periodic sequence of six amplitude height values comprising three constant positive values P and three constant negative values −P is detected as said characteristic signal.

37. An apparatus according to one of the claims 33 to 36 wherein said second means are implemented in such a way that a periodic sequence of the amplitude height values P, 0, P, −P, 0, −P with 0 being the smallest valid amplitude height value and P being any other valid amplitude height value is detected as said characteristic signal.

38. An apparatus according to one of the claims 33 to 37, wherein for modem detection amplitude height values with a deviation of up to two levels from the amplitude height values required for detection are mapped to that amplitude height value.

39. An apparatus according to one of the claims 33 to 38, further comprising a modem detection unit, in particular one according to claims 30 to 34.

40. A codec device (21) that contains an apparatus according to one of the apparatus claims.

41. A network termination unit (2) that contains an apparatus according to one of the apparatus claims.
